(19) United States
(12) Patent Application Publication
(10) Pub. No.: US 2005/0110758 A1
(43) Pub. Date: May 26, 2005

(54) Tactile mouse interface system

(76) Inventors: Ki Uk Kyung, Jeollanam-do (KR); Seung Woo Son, Seoul (KR); Dong Soo Kwon, Daejeon (KR); Mun Sang Kim, Seoul (KR); Gi Hun Yang, Chungcheongnam-do (KR)

Correspondence Address: BRINKS HOFER GILSON & LIONE, P.O. BOX 10395, CHICAGO, IL, 60610, US

(21) Appl. No.: 10/955,426

(22) Filed: Sep. 30, 2004

(30) Foreign Application Priority Data
Oct. 21, 2003 (KR) 2003-73554

(51) Int. Cl. G09G 5/00; G09G 5/08

(52) U.S. Cl. 345/163

(57) ABSTRACT

A mouse interface system is provided that allows a user to feel a virtual object displayed by a computer on a display device. The system includes (a) a force feedback device for providing the user with kinesthetic feedback related to mechanical properties in a predetermined direction of the virtual object, (b) a tactile feedback device for providing the user with normal stimulation related to texture of the virtual object, and (c) a linear actuator for providing the tactile feedback device with a translational movement so that the distal end portion of each pin moves in a substantially lateral direction with respect to the user's skin.

### PRIORITY CLAIM

This application claims under 35 U.S.C. § 119 the benefit of the filing date of Oct. 21, 2003 of Korean Application No. 2003-73554, the entire contents of which are incorporated herein by reference.

### BACKGROUND

1. Technical Field

The invention relates to a mouse system for computers, which produces a force feedback, and more particularly, to a tactile mouse interface system for computers, which provides a force feedback to a user's wrist or arm, or provides tactile and kinesthetic feedback of a virtual object to the user's fingers.

2. Related Art

In general, computer users experience virtual objects in games and simulations based on virtual realities, which are provided by computers. Interface devices used for computer-user interaction include a mouse, a joystick, a steering wheel, a tablet and so on. Such interface devices apply control signals or commands to virtual objects displayed on monitors of computers, or allow users to physically feel the virtual objects. Accordingly, interface devices require force feedback units, which are familiar to users so as to allow users to feel virtual objects.

U.S. Pat. No. 6,191,774 discloses a conventional mouse interface system that provides force feedback to a user's hand as shown in FIG. 1. A mouse interface system 40 is connected to a host computer and provides force feedback to a user's hand. A user can feel feedback of a virtual object. Specifically, the mouse interface system 40 includes a mouse 10, a mechanical linkage 20 and a transducer system 30. The mechanical linkage 20 is provided on a base member 25. First, second, third and fourth links 21, 22, 23 and 24 are connected to each other in the mechanical linkage 20, and the mouse 10 is connected to one end of the fourth link 24. In this case, the mechanical linkage 20 is rotatably coupled to one or more bearings, so that force feedback is transmitted to the mouse 10 by the operation of the linkage 20.

The transducer system 30 includes a sensor 31 and actuators 32. The sensors 31 collectively sense a movement of the mouse 10 and transmit electric signals, and the actuator 32 transmits forces to the mouse 10 in two degrees of freedom according to shape of a virtual object.

With the above-described configuration, the mouse interface system 40 provides force feedback to a user's hand holding the mouse 10 in such a way that the transducer system 30 operates the linkage 20 according to the shape of a virtual object. The conventional mouse interface system has disadvantages that a user can feel indirect tactile sensation of a virtual object. A user is not allowed to perceive various physical properties of a virtual object, such as size, weight, shape and hardness.

Another conventional mouse interface systems are disclosed U.S. Pat. Nos. 5,912,660 and 6,278,441. These systems allow a user to feel tactile feedback of a virtual object implemented on a computer. However, the mouse interface systems are limited to provide only force feedback to feel physical properties of a virtual object. The systems are not configured to allow a user to feel kinesthetic feedback (e.g., tactile sensation generated when a virtual object is grazed). The entire contents of each U.S. Pat. Nos. 6,278,441, 6,191,774 and 5,912,660 are incorporated herein by reference.

### SUMMARY

An object of the invention is to provide a mouse interface system for providing tactile and kinesthetic feedback, which linearly move pins operated by bimorph actuators, in order to transmit the pressure distribution, vibration and grazing sensation of a virtual object to a user's fingers while transmitting force feedback to a user' arm. A user can feel the various physical properties of the virtual object, such as weight, size, shape and hardness of a virtual object.

Another object is to provide a mouse interface system for providing tactile and kinesthetic feedback, which is capable of providing tactile and force sensations to a user's fingers, such as the thumb and the index finger without disturbing movement of the user's arm and wrist. This substantially minimizes inconvenience and fatigue that a user may feel.

In order to accomplish the above object, one embodiment of a mouse interface system for computers is provided. The mouse interface system for computers provides force feedback to the user's palm and arm by operating a mouse, and provides force feedback or stimulus to the user's fingers by operating pins placed in a mouse. A user indirectly feels a virtual object on the monitor of a computer. A tactile feedback stimulating unit installed in the mouse transmits stimuli or pressure to a user's fingers by operating one or more individual actuators according to signals related to a virtual object and controlling the individual pins attached to the actuators. The mouse transmits active kinesthetic feedback to a user's fingers by receiving a signal related to kinesthetic feedback, which occurs when the virtual object is grazed, from an encoder and linearly moving a slide operated in conjunction with the tactile feedback stimulating unit.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram of a conventional mouse interface system that provides force feedback to a user's hand;

FIG. 2 is a schematic diagram showing one embodiment of a mouse interface system;

FIG. 3 is a perspective view of the mouse interface system shown in FIG. 2;

FIG. 4 is a perspective view of the mouse interface system of FIG. 3 with a mouse plate removed;

FIG. 5 is a perspective view showing an internal structure of the mouse that transmits tactile and kinesthetic feedback in the mouse interface system shown in FIG. 4;

FIG. 6 is a perspective view and FIG. 7 is a plan view, which show a tactile feedback stimulating unit used in a mouse shown in FIG. 5;

FIG. 8a is a perspective view showing one of bimorph actuators that stimulate user's fingers in the tactile feedback stimulating unit shown in FIG. 6;

FIG. 8b is an enlarged perspective view showing pins shown in FIG. 8a;

FIG. 9 is a perspective view showing a mechanism of linearly operating the tactile feedback stimulating unit 110 in the mouse 100 shown in FIG. 5;

FIG. 10 is a perspective view of a force feedback unit used in the mouse interface system shown in FIG. 3; and

FIG. 11 is a partial perspective view of the force feedback unit showing a connection of the motor shaft that operates a linkage shown in FIG. 10.

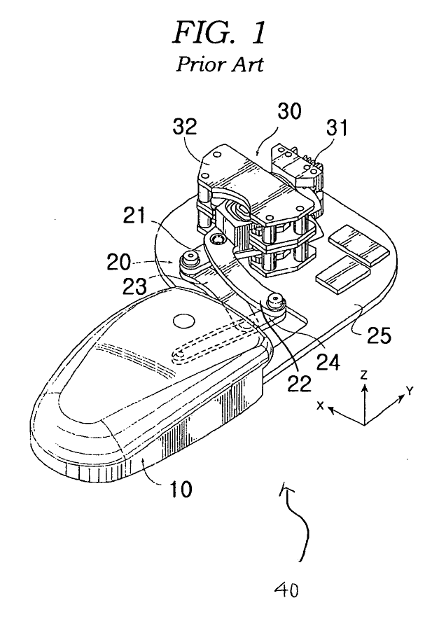

### DETAILED DESCRIPTION OF THE PREFERRED EMBODIMENTS

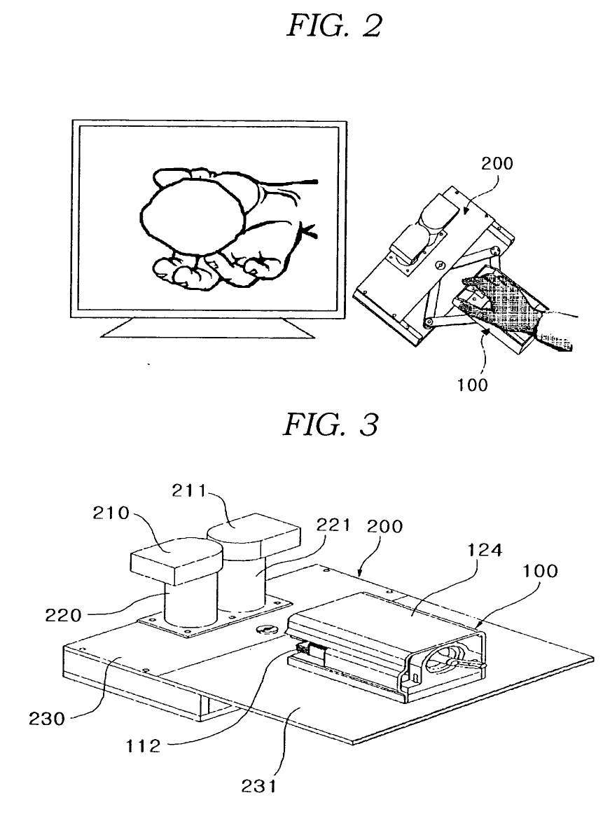

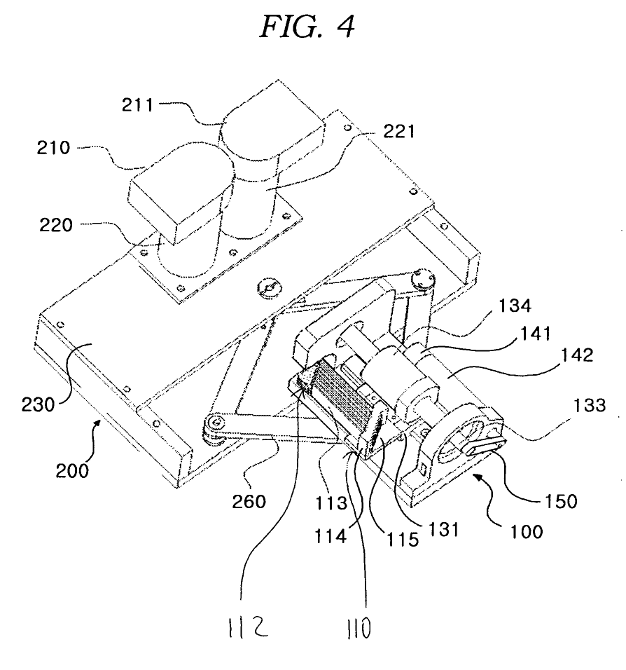

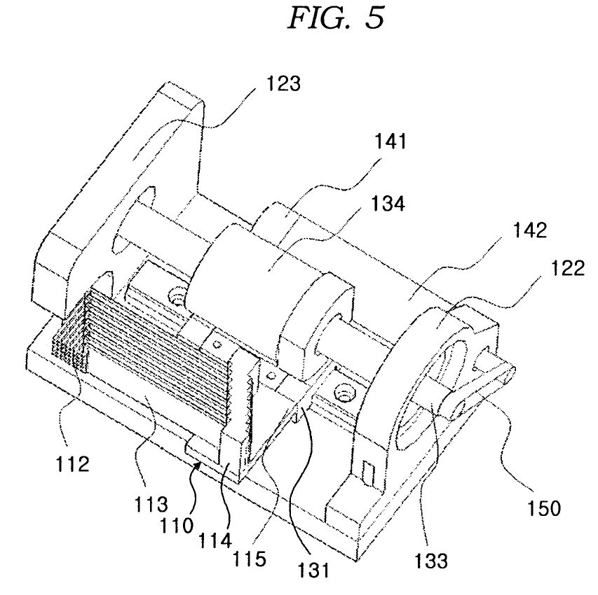

FIGS. 2 to 4 show one embodiment of a mouse interface system. FIG. 2 show s a mouse interface system that provides tactile and kinesthetic feedback to users. Users can feel a virtual object disposed on a monitor of a computer as shown in FIG. 2. Referring to FIG. 3, the mouse interface system includes a mouse 100 and a force feedback unit 200. The mouse 100 includes a plurality of pins 112, multiple actuators 113, and a tactile feedback stimulating unit 110. The force feedback unit 200 includes a second motor 220, a third motor 221 and a linkage 260. The linkage 260 is disposed below a mouse plate 231. The linkage 260 connects the mouse 10 to the force feedback unit 200 as shown in FIG. 4.

The mouse interface system stimulates fingers through the plurality of pins 112 by operating the actuators 113 of the tactile feedback stimulating unit 110. A user can feel a virtual object implemented on the monitor of a computer. Furthermore, the mouse interface system can transmit active kinesthetic feedback to the user's fingers by linearly moving the tactile feedback stimulating unit 110 in the mouse 100. The mouse interface system also allows a user gripping the mouse 100 to feel shape and hardness of a virtual object by operating the linkage 260 through the operation of second and third motors 220 and 221. Feedback is transmitted to the mouse 100, which is connected to the linkage 260.

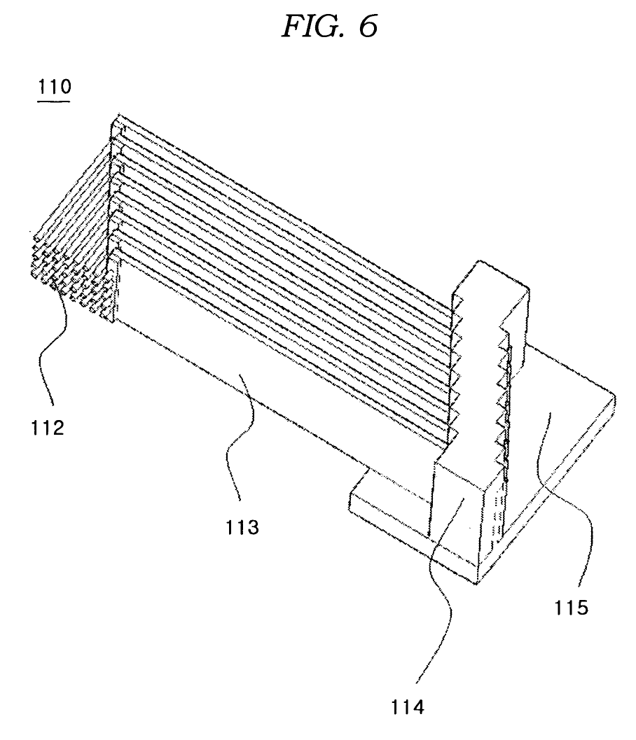

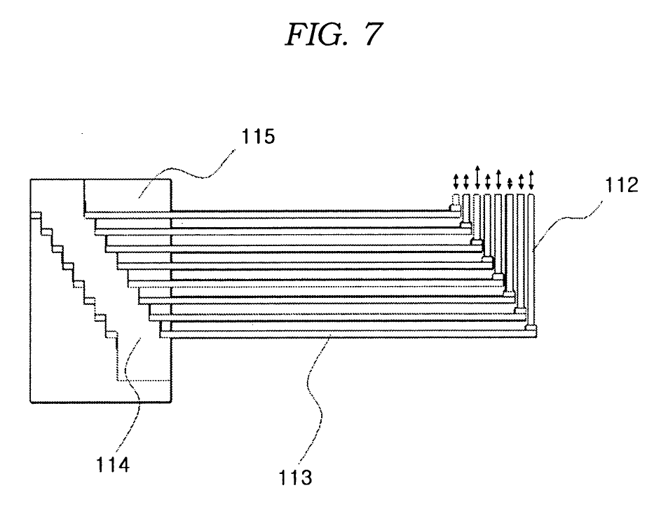

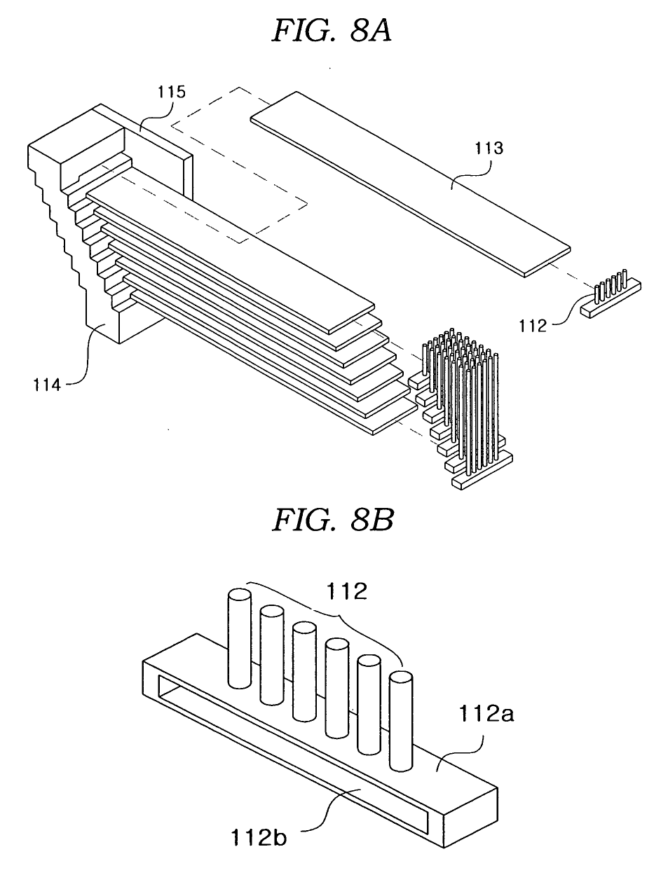

FIG. 5 shows an internal structure of the mouse 100 shown in 25 FIG. 4. FIGS. 6 and 7 show the tactile feedback stimulating unit 110 that applies stimuli to the user's fingers in the mouse shown in FIG. 5. FIG. 8a shows one of bimorph actuators that stimulate the user's fingers in the tactile feedback stimulating unit shown 110 in FIG. 6.

As shown in FIGS. 2 to 8, the tactile feedback stimulating unit 110 is disposed in the mouse 100 and transmits tactile feedback of a virtual object to user's fingers. The actuators 113 of the tactile feedback stimulating unit 110 are, for example, bimorph bending type piezoelectric actuators 113. The plurality of pins 112 are perpendicular and attached to the actuators 113. The actuators 113 control and operate the pins 112 at a predetermined frequency, amplitude and force in accordance with a current applied thereto. The tactile feedback stimulating unit 110 includes three electric wires that are connected to each of the actuators 113. Signals according to shape of a virtual object are selectively transmitted to the plurality of actuators 113. With this construction, the plurality of pins 112 stimulate user's fingers through the operation of the actuators 113 in accordance with shape of a virtual object. In this embodiment, the actuators 113 can be controlled at a frequency of about 1 kHz, which is the upper limit of vibration that can be sensed by a human body, and at a resolution of several micrometers of a front end amplitude. Accordingly, the tactile feedback stimulating unit 110 may form a different pressure distribution by differentiating each height of and force applied to pins 112 attached to the actuators 113. Furthermore, the tactile feedback stimulating unit 110 simulates superficial properties of a virtual object by making a frequency and/or an amplitude of the pin 112 differ from those of other pins. A user can feel tactile feedback of a virtual object.

As shown in FIGS. 6 and 7, the actuators 113 are attached to stepped portions of an actuator fastening stand 114. The actuator fastening stand 114 is attached to a first fastening plate 115 to support the actuators 113. The plurality of pins 112 are attached to one end of each of the actuators 113. In this embodiment, as shown in FIG. 8B, the plurality of pins 112 is attached to a block 112a having a lateral slot 112b and the plurality of pins 112 are combined with each actuator 113 through the block 112a. Specifically, the lateral slot 112b of the block 112a is tightly fitted around the actuator 113. When the actuator 113 and the pins 112a are combined with each other in that way, the pins 112 can be easily displaced when necessary. However, it is possible to directly attach the pins 112 to each actuator 113.

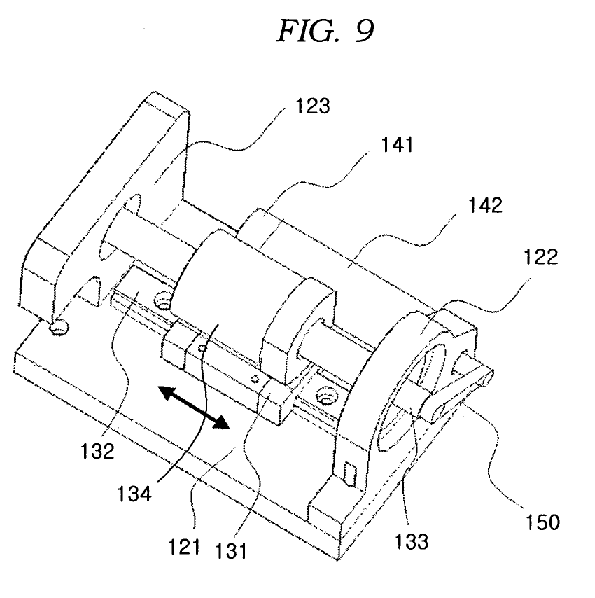

FIG. 9 illustrates a linear operation of the tactile feedback stimulating unit 110 included in the mouse 100 shown in FIG. 5. As shown in FIGS. 4, 5 and 9, the tactile feedback stimulating unit 110 is linearly moved in the mouse 100 so that the user can feel kinesthetic feedback. A signal indicating a location where a virtual object is grazed is transmitted to a first encoder 141 of the mouse 100. Subsequently, a first motor 142 connected to the first encoder 141 is operated to allow the tactile feedback stimulating unit 110 to be linearly moved. The motor shaft of the first motor 142 is connected to a screw shaft 133 via a driving belt 150 so that the screw shaft 133 is operated in conjunction with the first motor 142 in accordance with the rotation of the first motor 142. In this case, one side of the motor shaft of the first motor 142 and the screw shaft 133 are supported by a first support surface 122 and the other side of the screw shaft 133 is rotatably supported by a second support surface 123.

A slide 134 radially surrounds the screw shaft 133 to move along the length of the screw shaft 133. A thread is formed along the length of the screw shaft 133. A thread is formed on the slide 134 to engage with the thread of the screw shaft 133. The slide 134 is combined with a second fastening plate 131, which is attached to the first fastening plate 115 of the tactile feedback stimulating unit 110. The second fastening plate 131 is combined with a linear guide 132 to move parallel to the screw shaft 133. The linear guide 132 is attached to a bottom of the housing of the mouse 100.

With the above construction, the slide 134 linearly moves in the longitudinal direction of the screw shaft 133 while being guided by the linear guide 132 in accordance with the operation of the first motor 142. The tactile feedback stimulating unit 110 operates in conjunction with the slide 134, so that the pins 112 apply stimulus to a user's fingers when they graze a user's fingers.

Alternatively or additionally, a motor or solenoid whose operation shaft moves in a rectilinear direction, can be mounted in a mouse interface system, in place of the first encoder 141 and the first motor 142. The slide 134 is connected to that motor or solenoid, and linearly moves by the operation of the motor shaft or solenoid (not shown).

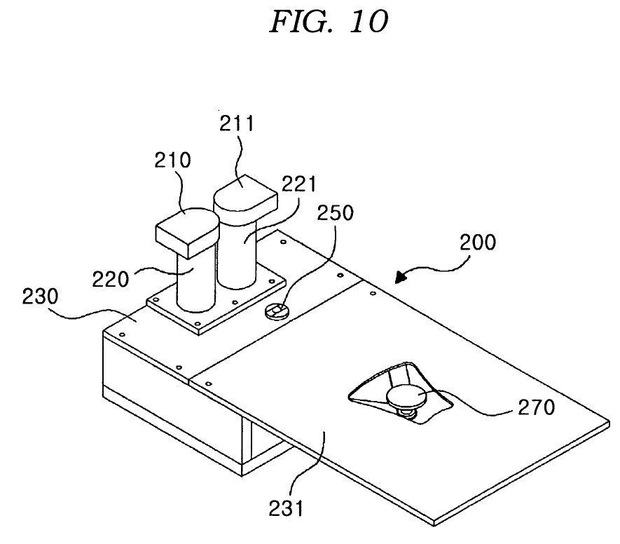

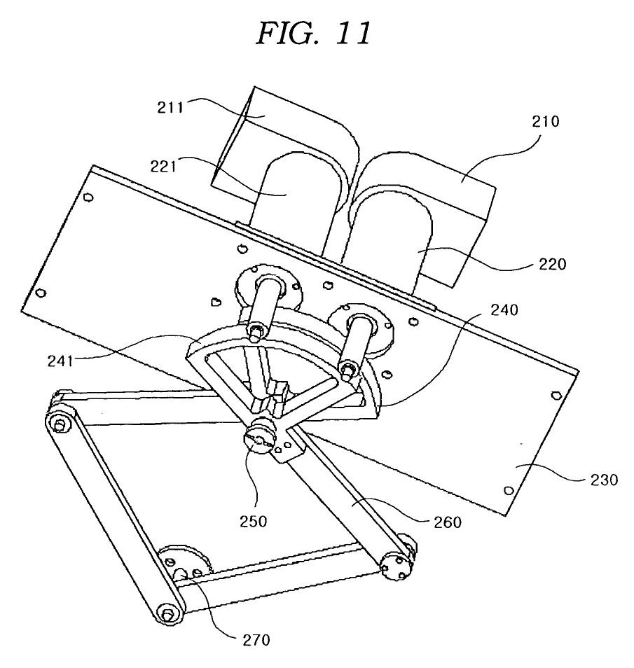

The mouse 100 transmits force feedback to a user through the operation of the linkage 260 of the force feedback unit 200 as shown in FIG. 10. FIG. 11 is a partial perspective view of the force feedback unit 200 showing a connection of the motor shaft that operates the linkage 260 shown in FIG. 10.

As shown in FIGS. 3, 4, 10 and 11, the force feedback unit 200 includes a frame 230 including two plates spaced apart from each other at a predetermined interval. The second and third motors 220 and 221 are mounted on a top plate of the frame 230, and second and third encoders 210 and 211 are attached to the second and third motors 220 and 221, respectively. The second and third motors 220 and 221 are connected to the four-member linkage 260 inside the frame 230. As shown in FIG. 11, the linkage 260 is held by a first joint 250 attached to the top of the frame 230. Two link connecting members 240 and 241 are coupled to the motor shafts of the second and third motors 220 and 221 via cables, respectively. The link connecting members 240 and 241 are rotatably fitted around a first joint 250. The link connecting members 240 and 241 are securely attached to the two links of the linkage 260, so that the linkage 260 is operated by the rotation of the second and third motors 220 and 221. A second joint 270 is placed at the location of the linkage 260 opposite to the first joint 250 and is attached to the bottom 121 of the housing of the mouse 100.

Referring to FIG. 10, a mouse plate 231 attached to the top of the frame 230 is placed between the mouse 100 and the linkage 260 to reduce user fatigue. A connection opening is formed through the mouse plate 231 to interconnect the second joint 270 and the mouse 100. The connection opening is configured to be larger than an operational range of the second joint 270. The operation range of the second join 270 may be polar a planar, coordinate range.

The operation of the mouse interface system is described below. The mouse interface system applies stimuli to a user's fingers holding the mouse 100 to allow a user to feel the properties of a virtual object displayed on the monitor of a computer. For this purpose, the tactile feedback stimulating unit 110 of the mouse 100 operates the individual pins 112 attached to the plurality of actuators 113 according to signals related to the virtual object, so that the tactile feedback stimulating unit 110 transmits a pressure stimulus, vibration or a tactile sensation to the user's fingers.

The mouse interface system operates the tactile feedback stimulating unit 110 of the mouse 100 to linearly move to allow a user to feel the kinesthetic feedback of a virtual object. Specifically, a signal indicating a location where a virtual object is grazed is transmitted to the second and third encoders 210 and 211, and the first motor 142 rotates the motor shaft. The slide 134 surrounding the screw shaft linearly moves along the screw shaft 133, which operates in conjunction with the motor shaft. The slide is simultaneously guided by the linear guide 132. The tactile feedback stimulating unit 110 connected to the slide 134 linearly moves.

Furthermore, the mouse interface system allows a signal, which corresponds to a palm holding a virtual object on a monitor, to be transmitted to the force feedback unit 200 through the second and third encoders 210 and 211. Then, the force feedback unit 200 operates the second and the third motors 220 and 221 according to signals input to the second and third encoders 210 and 211. The linkage 260 integrated with the mouse 100 operates. The mouse 100 transmits force feedback to the user's palm and arm through the operation of the linkage 260, so that the user can feel the tactile force, weight, size and hardness of a virtual object.

As described above, a mouse interface system provides advantages that by transmitting force feedback to a user's arm, a user can feel the weight, size and hardness of a virtual object implemented on the monitor of a computer, and by transmitting vibrations and a grazing stimulus to a user's fingers, a user can feel roughness and superficial properties of the virtual object.

A mouse interface system may be used in various fields, such as a part assembly of Computer Aided Design (CAD), product purchases in on-line shopping malls, and experience of virtual objects on computer games, so that a user senses and uses the properties of virtual objects on the monitor of a computer.

It is therefore intended that the foregoing detailed description be regarded as illustrative rather than limiting, and that it be understood that it is the following claims, including all equivalents, that are intended to define the spirit and scope of this invention.

1. A mouse interface system allowing a user to feel a virtual object displayed by a computer on a display device, comprising:
(a) a force feedback device providing the user with a kinesthetic feedback related to mechanical properties in a predetermined direction of the virtual object, the force feedback device including:
a mouse contacting with a hand of the user's ;
a linkage on which the mouse is installed, the linkage providing the mouse with two dimensional movements;
at least one motor for operating the linkage by applying torque to a joint of the linkage in accordance with output signals of the computer, wherein the output signals relate to the mechanical properties in the predetermined direction of the virtual object; and
at least one encoder for determining a position of the mouse based on a rotation angle of the joint of the linkage to which the torque of the at least one motor is applied, an output signal of the at least one encoder being provided to the computer.

2. The mouse interface system of claim 1, further comprising:
(b) a tactile feedback device providing the user with normal stimulation related to texture of the virtual object, the tactile feedback device including:
a base,
a plurality of plate-shaped actuators connected to the base, and
a plurality of pins arranged along a distal edge of each plate-shaped actuator, a distal end portion of a pin contacting the user's skin,
wherein the plurality of plated-shaped actuators operate simultaneously by electric signals representing the texture of the virtual object.

3. The mouse interface system of claim 2, further comprising:
(c) a linear actuator providing the tactile feedback device with a translational movement so that the distal end portion of each pin moves in a substantially lateral direction with respect to the user's skin.

4. The mouse interface system of claim 2, wherein the distal edge of the each plate-shaped actuator is arranged successively farther from the base and a pin arranged on a distal edge relatively far from the base have a length longer than that of a pin arranged on a distal edge relatively adjacent the base so that the distal end portions of the pins are located on a single plane.

5. The mouse interface system of claim 2, wherein the base of the tactile feedback device includes a step-shaped side and proximal end portions of the plated-shaped actuators are installed on the step-shaped side.

6. The mouse interface system of claim 3, wherein the linear actuator includes an actuating motor, a threaded shaft driven by the actuating motor, and a slide portion connected to the threaded shaft and to the base of the tactile feedback device, the slide portion moving reciprocally in a substantially parallel direction to the threaded shaft.

7. The mouse interface system of claim 6, wherein a shaft of the actuating motor and the threaded shaft are installed parallel to each other on the mouse and are connected by a timing belt.

8. The mouse interface system of claim 2, wherein the tactile feedback device further includes connecting portions on which the plurality of pins are arranged, each connecting portion being installed on the distal edge of each plate-shaped actuator.
